(19) United States
(12) Patent Application Publication
(10) Pub. No.: US 2008/0051502 A1
(43) Pub. Date: Feb. 28, 2008

(54) Soil amendment composition for athletic fields and method of making the same

(76) Inventors: Gregory DeRosa, Jericho, NY (US); David H. Stern, New York, NY (US)

Correspondence Address: ALIX YALE & RISTAS LLP, 750 MAIN STREET, SUITE 1400, HARTFORD, CT, 06103, US

(21) Appl. No.: 11/507,796

(22) Filed: Aug. 22, 2006

(51) Int. Cl. C08K 9/04

(52) U.S. Cl. 524/445

(57) ABSTRACT

A soil amendment suitable for sports field and tracks, in which the basic components of sand, silt, and clay are modified by the addition of calcined clay and a dry, essentially pure powdered resin. The preferred embodiment includes the further addition of a dry, essentially pure, powdered cellulosic material. Most preferably, powdered iron oxide is also present as a coloring agent. In a typical implementation, the soil amendment composition results from a mixture of sized sand, silt, and clay, mined from a natural source, which is then mixed with calcined clay, iron oxide, dry resin and cellulosic material. The composition is preferably prepared in bulk using a two-part procedure. In the first part of the procedure, the raw materials are mined and screened for size, then mixed to provide a first composition having a specific size profile. In the second part of the procedure, the first composition is bulk-blended with calcined clay, iron oxide, dry resin and cellulosic material to provide a second composition having preferred proportions of components.

### FIELD OF THE INVENTION

This invention relates generally to sports field conditioners used for constructing, renovating, and top-dressing various kinds of athletic fields and tracks.

### BACKGROUND ART

Athletic fields such as baseball fields, softball fields, soccer fields and football fields are subject to extreme conditions over extended periods of time. Without an effective field maintenance program, a sports field surface can quickly degrade to the point where the field will become unusable. Surface damage due to heavy foot traffic, inclement and often harsh weather conditions, as well as overuse makes effective field management increasingly difficult. These problems are often exacerbated by the poor physical structure of most soils, as well as improper field construction and poor field maintenance practices.

For baseball and softball fields in particular, proper field maintenance is a complicated and time-consuming process. At a minimum, a ball field maintenance program involves caring for grass (cutting, watering, aerating, fertilizing, re-seeding, etc.), dragging the infield to break up the surface and remove any unwanted vegetation, lining the field as well as repairing any damage to either the grass or the infield surfaces. General maintenance issues aside, the most common problem in baseball and softball field construction and maintenance is achieving an infield surface that is durable as well as “playable” in all weather conditions. At the same time, budgetary and personnel constraints create a demand for infield surfaces that are easy to maintain with a minimum number of caretakers.

Considering that most of the activity during a baseball or softball game takes place in the infield, providing an infield that is durable, versatile, and practical is a tall order. Further complicating matters is the fact that the composition of infields varies across the country and around the world. Even Major League Baseball lacks a standard composition for the infields of large commercial ballparks. Attaining an optimally performing infield is a difficult task, however, identifying a poor infield surface is easy.

As a result, an entire industry has developed around sports field maintenance. This industry provides groundskeepers and coaches with information, materials, and tools that help make infields more playable. For example, there are conferences and seminars on topics such as infield construction and maintenance practices, as well as trade shows that feature specialized field maintenance products and equipment. The importance of having a high performing infield is also reflected in the substantial amounts of money and time invested by universities, municipalities, and private industry in attempting to understand and perfect infield maintenance and construction. Governing bodies and professional organizations have been created to try to standardize maintenance practices and to provide recommendations to groundskeepers and coaches. But despite these recent advances in knowledge and techniques, a consistently performing infield still presents many challenges.

Desirable characteristics for infield playability include a smooth, level surface for running, sliding and fielding balls, and an attractive, friable surface having between ¼ inch and ½ inch of loose surface material that provides a cushioned surface for ball hops and running, while also keeping skin abrasions to a minimum during sliding contact with the surface. In addition, an infield surface should not become slippery when wet. Optimally, the surface should absorb light rains and provide surface drainage during heavy rains. The surface should also dry out quickly in wet weather, but should not become too dry or become hard and crack. This is especially important during the hot summer months or in arid regions where there is little irrigation. In other words, the infield surface should be capable of retaining minimum moisture levels under a variety of conditions. Finally, the infield surface should be easy to scarify or break up by using a mat, rake, nail drag or other implement that reduces surface compaction.

The most common method of improving the playability of an infield is to modify infield soils by adding soil amendments that will help absorb moisture as well as help the field remain loose and friable. There are several objectives to adding amendments to infields, including: improving moisture absorption, reducing compaction, smoothing the uppermost surface, improving drainage, imparting a color to the surface, and loosening the uppermost surface to improve sliding capabilities. Of course, the effectiveness of these products varies widely.

A number of soil amendments have been tried in the past, such as sand, cat litter, diatomaceous earth, and crushed aggregates including brick, limestone, sandstone, shale, etc. Several properties are often used to differentiate between the different amendments. These properties include particle size, moisture absorption capability, color, and physical stability.

Because of its small particle size, sand is not a generally acceptable amendment. In most cases, sand encourages soil compaction because it fills the available pore space in a soil mixture. Other properties that make sand less desirable include its negligible water absorption and retention capacity. While soils containing a very high sand content generally drain rapidly, there are usually no empty pores available in the soil to retain the residual moisture necessary to obtain optimum playability. This water retention characteristic is especially important during hot summer months.

Not all materials are applied to the entire infield surface. For example, some amendments act only as drying agents and are “spot applied” to the infield to absorb surface water. The most effective of these spot treatments are products that contain ground corncobs. These products must be removed from the infield once the surface water is absorbed; otherwise these products will become slippery when the infield is rewet by rain or other water.

Cat litter is another material used by groundskeepers to absorb moisture on infields following a downpour. Cat litter is a dried clay composition that contains substantial amounts of sodium and/or magnesium bentonites or other clays that swell in the presence of water. Although these products absorb water, the absorbed water rehydrates the dried clay, which in turn breaks down quickly to form a wet and often slick mass. Unlike the corncob-containing products, cat litter is not usually removed from the infield surface. Instead it is spread around and becomes incorporated into the surface over time. However, if used too often, cat litter can also produce an infield surface that is slippery when wet. Cat litter also contributes to poor drainage by clogging the intergranular drainage passages in the remaining soil mix. For these reasons, cat litter it is not generally used to provide a consistent infield surface.

Similarly, materials such as calcined diatomaceous earth, crushed sandstone, crushed limestone, and similar white or light-colored materials have not gained wide acceptance as soil amendments for sports fields. For baseball and softball infields in particular, these materials are unacceptable due to their light coloring. However, these materials exhibit other undesirable characteristics as well. For example, calcined diatomaceous earth is brittle and rapidly breaks down. Crushed brick and shale have also been used as amendments, but these materials have been found to contribute to cuts and skin abrasions during sliding. Although crushed brick may have the appropriate color for use on infields, crushed brick does not have the desired porosity. Moreover, both crushed brick and shale are known to decrease soil drainage.

Finally, because infield surfaces have such a diverse range of desired performance properties, compositions that are suitable for conditioning horse tracks or other sports surfaces such as tennis courts, are not generally applicable for use on infield surfaces.

There is a continuing need for a new and improved soil amendment that is inexpensive, promotes rapid drainage while also exhibiting acceptable water retention, a uniform and pleasing red-brown color, and promotes optimal playing characteristics. Further, the amendment should be resistant to physical and chemical break down and suitable for use as a below-surface additive as well as a top dressing.

### SUMMARY OF THE INVENTION

In a broad aspect, the invention is directed to a soil amendment suitable for sports field and tracks, in which the basic components of sand, silt, and clay are modified by the addition of calcined clay and a dry, essentially pure powdered resin. The preferred embodiment includes the further addition of a dry, essentially pure, powdered cellulosic material. Most preferably, powdered iron oxide is also present as a coloring agent.

In a typical implementation, the soil amendment composition results from a mixture of sized sand, silt, and clay, mined from a natural source, which is then mixed with calcined clay, iron oxide, dry resin and cellulosic material. The composition is preferably prepared in bulk using a two-part procedure. In the first part of the procedure, the raw materials are mined and screened for size, then mixed to provide a first composition having a specific size profile. In the second part of the procedure, the first composition is bulk-blended with calcined clay, iron oxide, dry resin and cellulosic material to provide a second composition having preferred proportions of components. In one preferred aspect of the invention, the materials are mixed without the addition of water. It is another aspect that the end product be prepared in high volume and that the mixing, particularly of the second composition, employs a front loader, on an asphalt pad or the like.

The soil amendment is preferably prepared by using quantities of each of the soil amendment constituents according to specific percentage ranges and mixing the constituents together until a composition that is substantially blended results.

The soil amendment composition of the present invention is durable, fast draining yet retains residual moisture, does not cause soil compaction, and provides a surface with an attractive color and appearance as well as superior playability.

### BRIEF DESCRIPTION OF THE DRAWINGS

There are no drawings.

### DETAILED DESCRIPTION

In one preferred embodiment of the invention, the composition is comprised of a size-screened mixture of sand, silt, and clay, which is then mixed with calcined clay, iron oxide, dry resin and cellulosic material. Preferably, the composition of the present invention is prepared and mixed in bulk without the addition of water.

In a preferred method, the soil amendment composition is prepared using a two-part procedure. In the first part of the manufacturing procedure, the raw materials are mined and screened for size to yield a first composition having a specific size profile. According to a preferred embodiment, the first composition comprises sand, silt, and clay with the following size profile:

| Sand Screen Size | Percent Passing |
|---|---|
| ¼″ (6.3 mm) | 100% |
| #4 (4.76 mm) | 98–100% |
| #10 (2.00 mm) | 90–98% |
| #18 (1.00 mm) | 80–95% |
| #35 (.50 mm) | 65–85% |
| #60 (.25 mm) | 20–40% |
| #140 (.105 mm) | 0–10% |
| #270 (.05 mm) | 0–2% |

silt size is about 0.002 mm-0.05 mm;

clay size is smaller than 0.002 mm.

In the second part of the manufacturing procedure, the first composition is bulk-blended with calcined clay, iron oxide, dry resin and cellulosic material so as to provide a second composition having preferred proportions of components. In a preferred embodiment, the second, final composition comprises the following by weight percent:

| | |
|---|---|
| Sand | 70–80% |
| Silt | 5–15% |
| Clay | 12–20% |
| Calcined Clay | 2–5% |
| Iron Oxide | 1–2% |
| Dry Resin | 1–2% |
| Cellulosic Material | 1–2% |

From the foregoing table it may be appreciated that the sand, silt, and clay pre-mix constitutes 90-95% by weight of the final mixture, whereas the balance constitutes about 5-10% of the final mixture.

It is an aspect of the invention to mix the materials in bulk without the addition of water. According to a preferred embodiment, the resin is a dry, 100% acrylic polymer. One suitable 100% acrylic powder is Drycryl™ DP-2903, which is manufactured by Rohm and Haas Company. In another preferred embodiment, the resin is dry, powdered polyvinyl acetate or vinyl acetate copolymer. Dow Latex Powder products, such as DLP 110 and DLP 220, are representative of dry powder polyvinyl acetate resins that are suitable for use with the present invention. Dow Latex Powder products are manufactured by the Dow Chemical Company.

The resin component aids in the even distribution of iron oxide throughout the soil amendment mixture during the mixing process, so as to impart a more vibrant and pleasing red-brown color to the final composition. The addition of resin also increases the longevity and durability of the color over time, despite exposure to wind, water, and UV light. Finally, the resin also improves the surface characteristics of the infield during wet or dry conditions by helping to maintain a friable yet cohesive surface. The benefits derived from the tendency of the dry resin particles to provide a modest degree of attraction which functionally forms a fine web-like matrix that retains other particles, especially the iron oxide, in the original, uniform distribution.

According to another preferred embodiment, the cellulosic material is dry, 100% pure, powdered methylcellulose or cellulose ether. One suitable cellulosic material is Methocel™, manufactured by the Dow Chemical Company. Cellulose-based materials such as Methocel™ are known to bind and retain water molecules. Adding such a constituent to the soil amendment improves both the water absorption and moisture retention characteristics of the infield surface. When present with the resin, the dry cellulosic particles remain well distributed.

The resin plays a multi-purpose role in achieving the optimum performance of the mix whether used as a several inch thick finish later on a new or reconstructed field or track, a thin topdressing on an existing field or track to modify the finish layer, or a patch material for mixing into deteriorated regions of an existing field or track. Thus, even without one or both of the iron oxide or cellulose component, the presence of the resin helps to maintain a friable yet cohesive surface due to the “web” effect discussed above. In such embodiment, the overall final composition would be at least about 90% sand, silt, and clay; about 2-7% calcined clay; and about 1-3% resin. As used herein, “soil amendment” should be understood in a broad sense of (1) an “amended soil” such as the result of mixing one or more of the calcined clay, resin, cellulose, and iron oxide with natural or engineered soil before shipping to an end user in bulk or bagged form, (2) a baseball infield or warning track that has been “amended” by the mixing in of calcined clay, resin, cellulose, and iron oxide into the top layer well as (3) a mixture of some or all of calcined clay, resin, cellulose, and iron oxide that is packaged or shipped in bulk to a purchaser who mixes the purchased material with soil on hand to thereby amend such soil. The soil on hand to be amended, could be natural or engineered soil, including unused or depleted infield top dressing.

Another aspect of the invention relates to the method of preparing the second composition described above, i.e., the in-bulk blending of the first composition with the other materials to create a final composition with its constituents in particular proportions. In a first preferred embodiment, the second composition is prepared using a payloader and the mixing-blending process takes place on a mixing pad. It is further preferred that the method of preparing the second composition is performed by depositing bulk quantities of each of the components according to the desired percentage ranges to form a heap totaling at least 10 tons on a mixing pad and using a payloader to repeatedly lift and drop all or portions of the heap until the components are blended.

According to a second preferred embodiment, the method of preparing the second composition is performed as follows: (a) at least about 10 tons of silt, sand, and clay (i.e. the first composition) are deposited as a pre-heap on a mixing pad; (b) the calcined clay, iron oxide, dry powdered resin and dry powdered methyl cellulose or cellulose ether are premixed to form a bulk pre-mix weighing at least about 1000 pounds; (c) the pre-mix is added to the pre-heap on the mixing pad to form a final heap; and (d) a payloader repeatedly lifts and drops all or portions of the final heap until the heap is blended.

In another embodiment of the method of the present invention, the soil amendment is prepared by using quantities of each of the soil amendment constituents according to specific percentage ranges and mixing the constituents together until a composition that is substantially blended results. According to this embodiment the mixing process can be performed in small batches, but the mixing should be gentle so to avoid the resin from congealing the mixture.

The soil amendment of the present invention is durable, fast draining yet retains residual moisture, does not cause soil compaction, and provides a surface with superior playability and appearance.

Exemplary embodiments illustrating the soil amendment composition and the method of blending components are described for purposes of explanation and are not intended as limitations of the invention herein. Alternative compositions and additional constituents may occur to one skilled in the art without departing from the spirit and the scope of the present invention.

1. A method for producing a soil amendment, comprising: screening and sizing a supply of raw sand, silt, and clay to achieve a first composition; and blending said first composition with calcined clay, iron oxide, dry powdered resin and dry powdered cellulosic material.

2. The soil amendment of claim 1 wherein said cellulosic material is selected from the group consisting of methylcellulose or cellulose ether.

3. The soil amendment of claim 1 wherein said resin is selected from the group consisting of acrylic polymer, polyvinyl acetate, and polyvinyl acetate copolymer.

4. The method of claim 1 wherein said blending is performed without the addition of water.

5. The method of claim 1, wherein
the screening and sizing achieves the following size distribution:

| Screen Size | Percent Sand Passing |
|---|---|
| ¼″ (6.3 mm) | 100% |
| #4 (4.76 mm) | 98–100% |
| #10 (2.00 mm) | 90–98% |
| #18 (1.00 mm) | 80–95% |
| #35 (.50 mm) | 65–85% |
| #60 (.25 mm) | 20–40% |
| #140 (.105 mm) | 0–10% |
| #270 (.05 mm) | 0–2% |

silt in the range of 0.002 mm-0.05 mm;
clay smaller than 0.002 mm; and
blending said screened sand, silt, and clay with calcined clay, iron oxide, dry powdered resin and dry powdered cellulosic material, achieves the following final composition by dry weight percent:

| | |
|---|---|
| Sand | 70–80% |
| Silt | 5–15% |
| Clay | 12–20% |
| Calcined Clay | 2–5% |
| Iron Oxide | 1–2% |
| Dry Resin | 1–2% |
| Cellulosic Material | 1–2% |

6. The method of claim 5, wherein the cellulose material is methylcellulose or cellulose either;

7. The method of claim 5, wherein said resin is selected from the group consisting of acrylic powder, polyvinyl acetate and polyvinyl acetate copolymer.

8. The method of claim 5 wherein the step of blending consists of mixing all the constituents on a large asphalt or similar flat pad.

9. The method of claim 8, wherein the blending is performed by depositing quantities of each of said constituents according to the specified percentages ranges, to form a heap totaling at least 10 tons on the pad, and using a payloader to repeatedly lift and drop all or portions of the heap until the heap is blended.

10. A method for producing a soil amendment for sports fields comprising (a) depositing at least about 10 tons of silt, sand, and clay as a pre-heap on a mixing pad, (b) premixing calcined clay, iron oxide, dry powdered resin and dry powdered methyl cellulose or cellulose ether to form a bulk pre-mix weighing least about 1000 pounds; (c) adding the pre-mix to the pre-heap on the mixing pad to form a final heap; and (d) repeatedly removing, lifting and dropping portions of the final heap with a mechanical bucket, until the heap is blended.

11. A soil amendment for sports fields consisting essentially of:
sand, silt, clay, calcined clay, iron oxide, dry resin, and dry powdered cellulosic material.

12. The soil amendment of claim 11, consisting essentially of: 70-80% sand, 5-15% silt, 12-20% clay, 2-5% calcined clay, 1-2% iron oxide, 1-2% dry resin, and 1-2% cellulosic material, all by weight.

13. The soil amendment of claim 11 wherein said dry resin is selected from the group consisting of essentially pure acrylic polymer, polyvinyl acetate, and vinyl acetate copolymer.

14. The soil amendment of claim 11 wherein said cellulosic material is selected from the group consisting of essentially pure methylcellulose and cellulose ether.

15. A soil amendment for sports fields comprising: at least about 90% by dry weight of sand, silt, and clay, about 3-7% by dry weight of calcined clay, and about 1-3% by dry weight of dry, powdered resin.

16. The soil amendment of claim 15, including about 1-3% by dry weight of iron oxide.

17. The soil amendment of claim 15, including about 1-3% by dry weight of dry powdered cellulosic material.

18. The soil amendment of claim 17, including about 1-3% by dry weight of iron oxide.

19. The soil amendment of claim 15 wherein said dry resin is selected from the group consisting of essentially pure acrylic polymer, polyvinyl acetate, and vinyl acetate copolymer.

20. The soil amendment of claim 17 wherein said cellulosic material is selected from the group consisting of essentially pure methylcellulose and cellulose ether.

21. A soil amendment consisting essentially of calcined clay, powered iron oxide, dry powered resin, and dry powered cellulose.

22. The soil amendment of claim 21, wherein the iron oxide, dry resin, and cellulose are each of a lesser weight quantity than the calcined clay.

23. A method of amending a top layer of a baseball infield or warning track comprising: blending into said top layer, a combination of calcined clay, powered iron oxide, dry powered resin and dry powered cellulose.

24. The method of claim 23, wherein the iron oxide, dry resin, and cellulose are each of a lesser weight quantity than the calcined clay.
